(19) United States
(12) Patent Application Publication
(10) Pub. No.: US 2019/0242225 A1
(43) Pub. Date: Aug. 8, 2019

(54) METHOD FOR EXTRACTING TIGHT OIL BY CONVERTING CARBON DIOXIDE HUFFING-PUFFING TO CARBON DIOXIDE FLOODING

(71) Applicant: China University of Petroleum (East China), Qingdao (CN)

(72) Inventors: Zhaomin LI, Qingdao (CN); Shouya WU, Qingdao (CN); Chao ZHANG, Qingdao (CN); Binfei LI, Qingdao (CN); Yuliang SU, Qingdao (CN); Guangzhong LV, Dongying (CN); Meijia WANG, Qingdao (CN)

(21) Appl. No.: 16/194,339

(22) Filed: Nov. 18, 2018

(30) Foreign Application Priority Data
Feb. 2, 2018 (CN) 201810104442.9

(51) Int. Cl. E21B 43/16; C09K 8/594; C09K 8/74

(52) U.S. Cl. CPC E21B 43/164; E21B 47/06; C09K 8/74; C09K 8/594

(57) ABSTRACT

A method for extracting tight oil includes the steps of performing several cycles of carbon dioxide huffing-puffing; selecting three adjacent cracks; installing a double-layered concentric oil tubing or two parallel oil tubes in a casing in the horizontal wellbore, and dividing space in the casing into an injection channel, an extraction channel a, and an extraction channel b; communicating the injection channel with the target injection crack; communicating the extraction channel a with the extraction crack a; and communicating the extraction channel b with the extraction crack b; injecting carbon dioxide from the wellbore into the injection channel, directing the crude oil into the extraction crack a and the extraction crack b from both sides of the target injection crack by carbon dioxide flooding and displacement, and extracting the crude oil along the extraction channel a and the extraction channel b.

### CROSS-REFERENCE TO RELATED APPLICATIONS

This application claims the benefit of priority from Chinese Application No. 201810104442.9, filed on Feb. 2, 2018. The content of the aforementioned application, including any intervening amendments thereto, is incorporated herein by reference.

### TECHNICAL FIELD

This application relates to the technical field of converting carbon dioxide huffing-puffing to carbon dioxide flooding in tight reservoirs, and more specifically, to a method for extracting tight oil by converting carbon dioxide huffing-puffing to carbon dioxide flooding.

### BACKGROUND

Since 2011, tight oil has developed fast throughout the world, and this is mainly due to the successful exploration and exploitation of tight oil in North America. The United States has successfully explored and exploited tight oil in areas such as Bakken, Eagle Ford, Barnet, Niobrara, Monterey/Samtos, and Utica. Under the influence of the “great development” of American tight oil, China's tight oil has developed rapidly in recent years. It is estimated that by 2020, China's dependence on foreign oil will probably exceed 60%. Shortages of oil and gas resources have become the main bottleneck for the sustainable and rapid development of China's economy and society. Therefore, the efficient development of tight oil is an important guarantee for national energy.

At present, the main processes for the development of tight reservoirs are: horizontal well multi-stage fracturing technology, volume fracturing technology and gas injection development technology. Gas injection development technology is generally implemented after the implementation of fracturing technology, and air, nitrogen, or carbon dioxide are commonly used. Due to unique physicochemical properties of carbon dioxide, carbon dioxide is considered as the best injection gas in the development of tight reservoirs. In recent years, some studies have shown that carbon dioxide huffing-puffing and flooding is a relatively effective technique in the development of gas injection in tight reservoirs. However, the permeability of tight oil reservoirs is very low, the formation pressure is reduced rapidly in depleted development, and thus the effect of carbon dioxide huffing-puffing and flooding is limited. According to the existing experimental results, the carbon dioxide huffing-puffing and flooding of tight reservoirs is worse after the second round of huffing-puffing, resulting in low recovery of tight reservoirs.

### SUMMARY

The object of this application is to solve the above-mentioned deficiencies of the prior art, and to provide a method for extracting tight oil by carbon dioxide huffing-puffing and flooding, which can effectively improve utilization of the tight oil reservoir and oil recovery.

A. injecting carbon dioxide of 0.1˜10 PV under reservoir condition into tight oil reservoir from a wellbore to fill space of cracks formed after fracturing;

B. well soaking;

C. after a pressure at a wellhead is stabilized, displacing crude oil by carbon dioxide flooding and directing it from the cracks to the wellbore to extract the crude oil;

D. repeating steps A to C until an output of the crude oil reaches an economic lower limit;

F. selecting three adjacent cracks, taking the crack in the middle as a target injection crack; and taking the cracks on both sides of the target injection crack in the injection direction as an extraction crack a and an extraction crack b;

G. installing a double-layered concentric oil tubing or two parallel oil tubing in a casing in the horizontal wellbore, and dividing space in the casing into an injection channel, an extraction channel a, and an extraction channel b;

H. communicating the injection channel with the target injection crack; communicating the extraction channel a with the extraction crack a; and communicating the extraction channel b with the extraction crack b;

I. injecting carbon dioxide from the wellbore into the injection channel, directing the carbon dioxide into the target injection crack along the injection channel and into the oil layer, directing the crude oil into the extraction crack a and the extraction crack b from both sides of the target injection crack by flooding and displacement, and extracting the crude oil along the extraction channel a and the extraction channel b.

Further, the double-layered concentric oil tubing includes an outer tube and an inner tube sleeved in the outer pipe, wherein an area inside the inner tube is the extraction channel b, an area between the outer tube and the inner tube is the injection channel, and an area between the outer tube and the casing is the extraction channel a.

Further, one of the two parallel oil tubing is the injection channel, the other is the extraction channel b, and an area between the two parallel oil tubes and the casing is the extraction channel a.

Further, the injection channel is provided with a screen section corresponding to the target injection crack, the injection channel communicates with the target injection crack through the screen section to form an injection guide channel.

Compared with prior art, the beneficial effects of the method for extracting tight oil by carbon dioxide huffing-puffing and flooding in this application are as follows: (1) by using this method, utilization of carbon dioxide injection in tight oil reservoirs can be effectively increased; interaction between carbon dioxide, crude oil and rock can be fully made use of; fluidity of dense oil reservoir can be increased; and recovery of tight reservoir can be greatly improved; (2) compared with carbon dioxide huffing-puffing technology, this application constructs an effective displacement pressure difference through crack spacing, which fully and effectively utilizes the geological reserves of matrix, and improves producing degree and oil recovery of the reservoir.

### BRIEF DESCRIPTION OF THE DRAWINGS

FIG. 1 is a schematic view showing the principle of injection and extraction using a double-layered concentric oil tubing according to this application.

FIG. 2 is a first schematic view of a method for extracting tight oil by carbon dioxide huffing-puffing and flooding according to this application.

FIG. 3 is a second schematic view of a method for extracting tight oil by carbon dioxide huffing-puffing and flooding according to this application.

In the figures: 1, oil layer boundary; 2, casing; 3, outer tube; 4, inner tube; 5-1, flow direction of carbon dioxide; 5-2, flow direction of crude oil; 6, screen section; 7, oil layer; 8. vertical well section; 9, target injection crack; 10, extraction crack a; 11, extraction crack b; 12, injection channel; 13, extraction channel a; 14, extraction channel b; 15, high pressure carbon dioxide storage tank; 16, surface injection equipment; 17, injection well; 18, horizontal well; 19, soking economic radius of the oil reservoir by carbon dioxide huffing-puffing technology; 20, tight oil reservoir; 21, packer.

### DETAILED DESCRIPTION OF EMBODIMENTS

In order to clarify the technical features of the present solution, the specific embodiments of this application will be further described below with reference to the accompanying drawings.

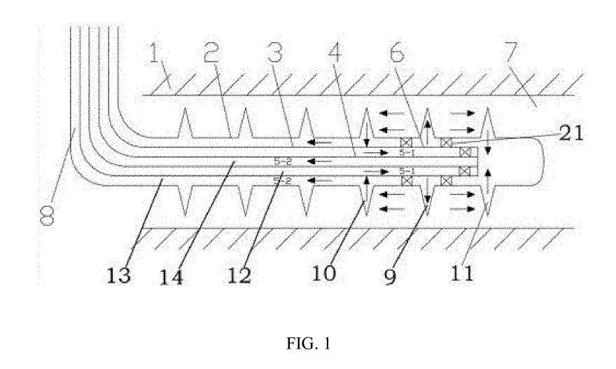

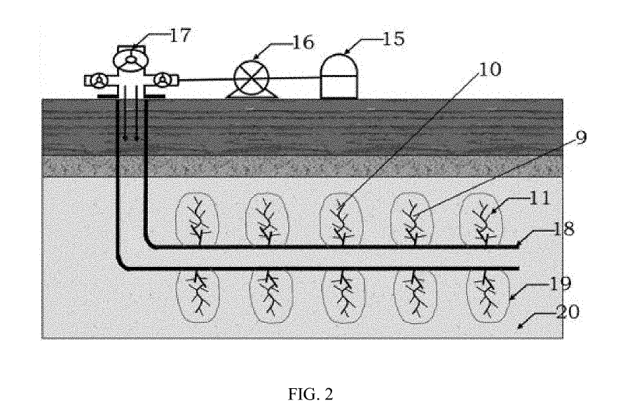

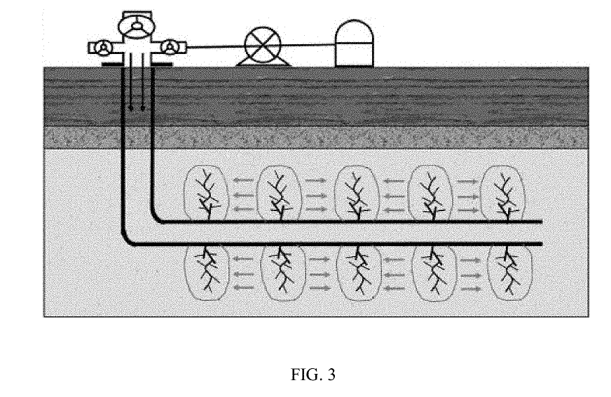

As shown in FIGS. 1 to 3, the high-pressure carbon dioxide storage tank 15 is connected to the surface injection equipment 16 through a pipe line, and carbon dioxide is delivered to the injection well 17 through a pipe line.

A method for extracting tight oil by carbon dioxide huffing-puffing and flooding, including the steps of:

A. injecting carbon dioxide of 1 PV under reservoir condition into tight oil reservoir from a wellbore by a surface injection equipment 16 to fill space of cracks formed after fracturing;

B. well soaking; during the well soaking, pressure changes are recorded. Carbon dioxide diffuses from the cracks to the matrix. Through component extraction and crude oil expansion, etc., the crude oil flows into the cracks from the matrix. In the presence of water phase, carbon dioxide dissolves in the water and forms acid liquor, which causes rock skeleton corrosion and improve the seepage characteristics of tight reservoir;

C. after pressure at wellhead is stabilized, crude oil displaced by carbon dioxide flows from the cracks to the wellbore to produced;

D. repeating steps A to C until a production of the crude oil reaches an economic lower limit;

F. selecting three adjacent cracks, taking the crack in the middle as a target injection crack 9; and taking the cracks on both sides of the target injection crack 9 in the injection direction as an extraction crack a 10 and an extraction crack b 11;

G. installing a double-layered concentric oil tubing or two parallel oil tubing in a casing 2 in the horizontal wellbore, the double-layered concentric oil tubing including an outer tube 3 and an inner tube 4 sleeved in the outer pipe 3, and dividing space in the casing 2 into an injection channel 12, an extraction channel a 13, and an extraction channel b 14 using a packer 21; wherein an area inside the inner tube 4 is the extraction channel b 14, an area between the outer tube 3 and the inner tube 4 is the injection channel 12, and an area between the outer tube 3 and the casing 2 is the extraction channel a 13; the injection channel 12 is provided with a screen section 6 corresponding to the target injection crack 9, the injection channel 12 communicates with the target injection crack 9 through the screen section 6 to form an injection guide channel;

H. communicating the injection channel 12 with the target injection crack 9; communicating the extraction channel a 13 with the extraction crack a 10; and communicating the extraction channel b 14 with the extraction crack b 11;

I. injecting carbon dioxide from the wellbore into the injection channel 12, directing the carbon dioxide into the target injection crack 9 along the injection channel 12 and into the oil layer 7, directing the crude oil into the extraction crack a 10 and the extraction crack b 11 from both sides of the target injection crack 9 by flooding and displacement, and extracting the crude oil along the extraction channel a 13 and the extraction channel b 14.

The embodiments of this application have been described in detail above with reference to the accompanying drawings, but this application is not limited to the above-described embodiments, and can be made various changes without departing from the spirit of this application within the knowledge of those skilled in the art.

What is claimed is:

1. A method for extracting tight oil by converting carbon dioxide huffing-puffing to carbon dioxide flooding, comprising:
A. injecting carbon dioxide of 0.1˜10 PV under reservoir condition into tight oil reservoir from a wellbore to fill space of cracks formed after fracturing;
B. well soaking;
C. displacing crude oil by carbon dioxide flooding and directing it from the cracks to the wellbore to extract the crude oil after a pressure at the wellhead is stabilized;
D. repeating steps A to C until an output of the crude oil reaches an economic lower limit;
F. selecting three adjacent cracks, taking the crack in the middle as a target injection crack; and taking the cracks on both sides of the target injection crack in the injection direction as a first extraction crack and a second extraction crack;
G. installing a double-layered concentric oil tubing or two parallel oil tubing in a casing in the horizontal wellbore, and dividing space in the casing into an injection channel, a first extraction channel, and a second extraction channel;
H. communicating the injection channel with the target injection crack; communicating the first extraction channel with the first extraction crack; and communicating the second extraction channel with the second extraction crack;
I. injecting carbon dioxide from the wellbore into the injection channel, directing the carbon dioxide into the target injection crack along the injection channel and penetrating into the oil layer, directing the crude oil into the first extraction crack and the second extraction crack from both sides of the target injection crack by flooding and displacement, and extracting the crude oil along the first extraction channel and the second extraction channel.

2. The method of claim 1, wherein the double-layered concentric oil tubing comprises an outer tube and an inner tube sleeved in the outer tube, wherein an area inside the inner tube is the second extraction channel, an area between the outer tube and the inner tube is the injection channel, and an area between the outer tube and the casing is the first extraction channel.

3. The method of claim 1, wherein one of the two parallel oil tubing is the injection channel, the other is the extraction channel b, and an area between the two parallel oil tubes and the casing is the first extraction channel.

4. The method of claim 1, wherein the injection channel is provided with a screen section corresponding to the target injection crack, the injection channel communicates with the target injection crack through the screen section to form an injection guide channel.

5. The method of claim 2, wherein the injection channel is provided with a screen section corresponding to the target injection crack, the injection channel communicates with the target injection crack through the screen section to form an injection guide channel.

6. The method of claim 3, wherein the injection channel is provided with a screen section corresponding to the target injection crack, the injection channel communicates with the target injection crack through the screen section to form an injection guide channel.
